(19) United States
(12) Patent Application Publication
(10) Pub. No.: US 2021/0286225 A1
(43) Pub. Date: Sep. 16, 2021

(54) OPTICAL SUBSTRATE, ELECTRO-OPTICAL DEVICE, AND ELECTRONIC APPARATUS

(71) Applicant: SEIKO EPSON CORPORATION, Tokyo (JP)

(72) Inventor: Shotaro IZAWA, NAGOYA-SHI (JP)

(73) Assignee: SEIKO EPSON CORPORATION, Tokyo (JP)

(21) Appl. No.: 17/200,909

(22) Filed: Mar. 15, 2021

(30) Foreign Application Priority Data
Mar. 16, 2020 (JP) 2020-045032

(51) Int. Cl. G02F 1/1362; G02F 1/1368

(52) U.S. Cl. CPC G02F 1/136286; G02F 1/1368; G02F 1/136209

(57) ABSTRACT

A first substrate, a pixel electrode disposed at the first substrate, a wiring layer including a transistor disposed between the first substrate and the pixel electrode, and a lens disposed between the pixel electrode and the wiring layer are included, wherein the lens is disposed, in plan view, in a display area that is an area in which the pixel electrode is disposed, and in a peripheral area outside the display area.

The present application is based on, and claims priority from JP Application Serial Number 2020-045032, filed Mar. 16, 2020, the disclosure of which is hereby incorporated by reference herein in its entirety.

### BACKGROUND

### 1. Technical Field

The present disclosure relates to an optical substrate, an electro-optical device, and an electronic apparatus.

### 2. Related Art

An active drive type liquid crystal apparatus including switching elements for pixels is known as an electro-optical device. Such a liquid crystal apparatus is used, for example, as a light valve of a projector as an electronic apparatus.

An optical substrate including a plurality of microlenses is used for the liquid crystal apparatus in order to suppress light loss. For example, JP-A-2019-40153 discloses a liquid crystal apparatus including a pixel electrode disposed in a display area on a substrate, a wiring layer including, for example, wiring disposed between the substrate and the pixel electrode, and a lens layer including a microlens disposed between the pixel electrode and the wiring layer and disposed at a position corresponding to the display area.

However, there is a problem that when the planarization process is applied to the upper surface of the entire lens layer, global steps may occur between the display area and the peripheral area thereof, resulting in a non-uniform cell gap and display unevenness.

### SUMMARY

An optical substrate includes a substrate, a pixel electrode disposed on the substrate, a wiring layer including a transistor disposed between the substrate and the pixel electrode, and a lens disposed between the pixel electrode and the wiring layer, wherein the lens is disposed, in plan view, in a display area that is an area in which the pixel electrode is disposed, and in a peripheral area outside the display area.

An electro-optical device includes the optical substrate described above, a counter substrate disposed opposite to the optical substrate, and an electro-optical layer disposed between the optical substrate and the counter substrate.

An electronic apparatus includes the electro-optical device described above.

### BRIEF DESCRIPTION OF THE DRAWINGS

FIG. 1 is a plan view schematically illustrating a configuration of a liquid crystal apparatus as an electro-optical device according to a first embodiment.

FIG. 2 is a schematic cross-sectional view taken along line H-H′ of the liquid crystal apparatus illustrated in FIG. 1.

FIG. 3 is an equivalent circuit diagram illustrating an electrical configuration of a liquid crystal apparatus.

FIG. 4 is a cross-sectional view illustrating a structure of the liquid crystal apparatus.

FIG. 5 is a plan view illustrating a partial structure of an element substrate.

FIG. 6 is a flowchart illustrating a method of manufacturing the element substrate.

FIG. 7 is a schematic view illustrating a configuration of a projector as an electronic apparatus.

FIG. 8 is a cross-sectional view illustrating a structure of the liquid crystal apparatus of a second embodiment.

FIG. 9 is a cross-sectional view illustrating a structure of the liquid crystal apparatus of a third embodiment.

FIG. 10 is a plan view illustrating an element substrate of a modified example.

FIG. 11 is a plan view illustrating the element substrate of the modified example.

FIG. 12 is a plan view illustrating a partial structure of a lens layer of a modified example.

FIG. 13 is a plan view illustrating a partial structure of a lens layer of a modified example.

FIG. 14 is a plan view illustrating a partial structure of a lens layer of a modified example.

### DESCRIPTION OF EXEMPLARY EMBODIMENTS

### First Embodiment

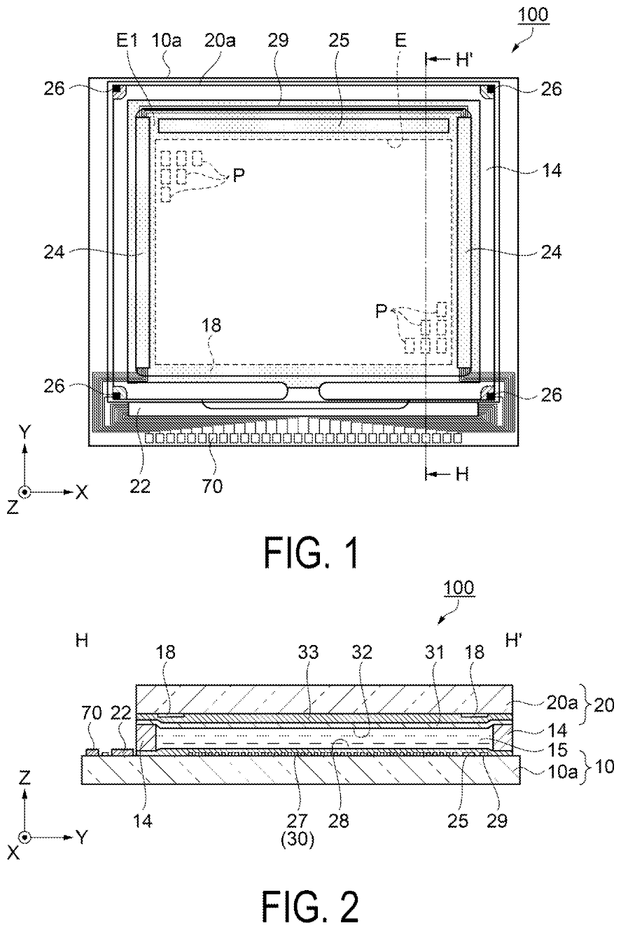

As illustrated in FIG. 1 and FIG. 2, a liquid crystal apparatus 100 of the present embodiment includes an element substrate 10 and a counter substrate 20 disposed opposite to each other, and a liquid crystal layer 15 as an electro-optical layer sandwiched between a pair of the substrates. A first substrate 10a as a substrate constituting the element substrate 10 and a second substrate 20a constituting the counter substrate 20 are, for example, glass, quartz, for example.

The element substrate 10 has a size greater than the counter substrate 20. Both substrates are joined through a seal material 14 disposed along an outer periphery of the counter substrate 20. In a gap therebetween, a liquid crystal having positive or negative dielectric anisotropy is encapsulated to form the liquid crystal layer 15.

As the seal material 14, for example, an adhesive such as a thermosetting or ultraviolet curable epoxy resin is employed. The seal material 14 includes, for example, a spacer configured to keep an interval between the pair of substrates constant.

Inside the seal material 14, a display area E is provided, in which a plurality of pixels P are arranged for contribution to the display. A peripheral area E1 is disposed around the display area E. Peripheral circuits, for example, are provided in the peripheral area E1, which do not contribute to display.

A data line drive circuit 22 is provided between the seal material 14 along one side portion of the element substrate 10 and the one side portion. In addition, an inspection circuit 25 is provided between the display area E and the seal material 14 along another one side portion facing the one side portion. Furthermore, scanning line drive circuits 24 are provided between the display area E and the seal material 14 along the other two side portions that are orthogonal to the one side portion and face each other. A plurality of wirings 29 connecting the two scanning line drive circuits 24 are provided between the inspection circuit 25 and the seal material 14 along the other one side portion facing the one side portion.

Inside the seal material 14 disposed in a frame shape on the counter substrate 20 side, a light-shielding film 18 is provided also in a frame shape. The light-shielding film 18 includes, for example, a metal or metal oxide having light-reflectivity. The inside of the light-shielding film 18 is the display area E including the plurality of pixels P. As the light-shielding film 18, for example, tungsten silicide (WSi) can be used.

The wiring is coupled to the data line drive circuit 22 and the scanning line drive circuits 24. The wiring is coupled to a plurality of external connection terminals 70 arranged along the one side portion. Hereinafter, description will be made with the direction along the one side portion being the X direction, and the direction along the other two side portions that are orthogonal to the one side portion and face each other being the Y direction. Further, the view from the Z direction is referred to as a plan view.

As illustrated in FIG. 2, a pixel electrode 27 having light reflectivity provided for each pixel P, thin film transistors as a switching elements (hereinafter referred to as “transistors 30”), data lines (not shown), and a first oriented film 28 covering these components are formed at the surface of the first substrate 10a on the liquid crystal layer 15 side.

The pixel electrodes 27 are formed of, for example, a transparent conductive film such as ITO (Indium Tin Oxide). The element substrate 10 in the present disclosure includes at least the pixel electrodes 27, the transistors 30, and the first oriented film 28.

The light-shielding film 18, an insulating layer 33 formed so as to cover the light-shielding film 18, a counter electrode 31 provided so as to cover the insulating layer 33, and a second oriented film 32 covering the counter electrode 31 are provided on the surface of the counter substrate 20 on the liquid crystal layer 15 side, The counter substrate 20 in the present disclosure includes at least the light-shielding film 18, the counter electrode 31, and the second oriented film 32.

As illustrated in FIG. 1, the light-shielding film 18 surrounds the display area E and is provided at a position where the scanning line drive circuits 24 and the inspection circuit 25 overlap in plan view. This serves to block the light incident on the peripheral circuits including these drive circuits from the counter substrate 20 side to prevent the peripheral circuits from malfunctioning due to the light. In addition, the display area E is shielded from light so that unnecessary stray light does not enter the display area E, thereby ensuring high contrast in the display of the display area E.

The insulating layer 33 includes, for example, an inorganic material such as silicon oxide, has light transparency, and is provided so as to cover the light-shielding film 18. Examples of the method for forming such an insulating layer 33 include a method of forming a film by using a plasma CVD (Chemical Vapor Deposition) method, for example.

The counter electrode 31 includes, for example, a transparent conductive film such as ITO. The counter electrode 31 covers the insulating layer 33, and is electrically coupled to the wiring on the element substrate 10 side by vertical conductive portions 26 provided at the four corners of the counter substrate 20 as illustrated in FIG. 1.

The first oriented film 28 covering the pixel electrodes 27 and the second oriented film 32 covering the counter electrode 31 are selected based on the optical design of the liquid crystal apparatus 100. The first oriented film 28 and the second oriented film 32 include an inorganic oriented film in which an inorganic material such as SiOx (silicon oxide) is formed by using the vapor phase growth method and oriented substantially perpendicular to liquid crystal molecules having negative dielectric anisotropy.

Such a liquid crystal apparatus 100 employs an optical design of the normally white mode that is a transmissive type and in which the transmittance of the pixels P with no voltage being applied thereto is greater than the transmittance with the voltage being applied thereto, or an optical design of the normally black mode in which the transmittance of the pixels P with no voltage being applied thereto is smaller than the transmittance with the voltage being applied thereto. A polarizing element is disposed on each of the light incidence side and the light exit side in accordance with the optical design to be used.

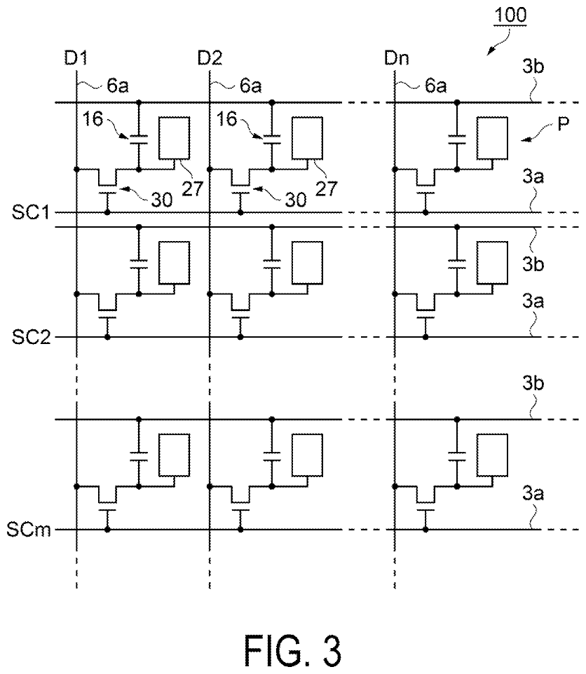

As illustrated in FIG. 3, the liquid crystal apparatus 100 has a plurality of scanning lines 3a and a plurality of data lines 6a that are insulated from each other and orthogonal to each other at least in the display area E, as well as capacitance lines 3b. For example, the direction in which the scanning lines 3a extend is the X direction, and the direction in which the data lines 6a extend is the Y direction.

The pixel electrodes 27, the transistors 30, and capacitance elements 16 are provided in areas divided by the scanning lines 3a, the data lines 6a, the capacitance line 3b, and these signal lines. These features form pixel circuits of the pixels P.

The scanning lines 3a are electrically coupled to the gates of the transistors 30. The data lines 6a are electrically coupled to the source areas of the transistors 30. The pixel electrodes 27 are electrically coupled to the drain areas of the transistors 30.

The data lines 6a are coupled to the data line drive circuit 22 (refer to FIG. 1), and supply image signals D1, D2, . . . , Dn supplied from the data line drive circuit 22 to the pixels P. The scanning lines 3a are coupled to the scanning line drive circuits 24 (refer to FIG. 1), and supply scanning signals SC1, SC2, . . . , SCm supplied from the scanning line drive circuits 24 to each pixel P.

The image signals D1 to Dn supplied from the data line drive circuit 22 to the data lines 6a may be supplied in this order with a line sequence, or may be supplied in groups to a plurality of the data lines 6a that are adjacent to each other. The scanning line drive circuits 24 supply the scanning signals SC1 to SCm to the scanning lines 3a with a pulsed line sequence at a predetermined timing.

The liquid crystal apparatus 100 is configured so that the transistors 30, which are switching elements, are on for a certain period of time by inputting the scanning signals SC1 to SCm, thereby the image signals D1 to Dn supplied from the data lines 6a are written to the pixel electrodes 27 at a predetermined timing. Then, the image signals D1 to Dn of a predetermined level written on the liquid crystal layer 15 via the pixel electrodes 27 are held between the pixel electrodes 27 and the counter electrode 31 that is disposed opposite to the pixel electrodes 27 via the liquid crystal layer 15 for a certain period of time.

In order to prevent the held image signals D1 to Dn from leaking, the capacitance elements 16 are connected in parallel with the liquid crystal capacitance formed between the pixel electrodes 27 and the counter electrode 31. A capacitance element 16 has a dielectric layer as a capacitance film between two capacitance electrodes.

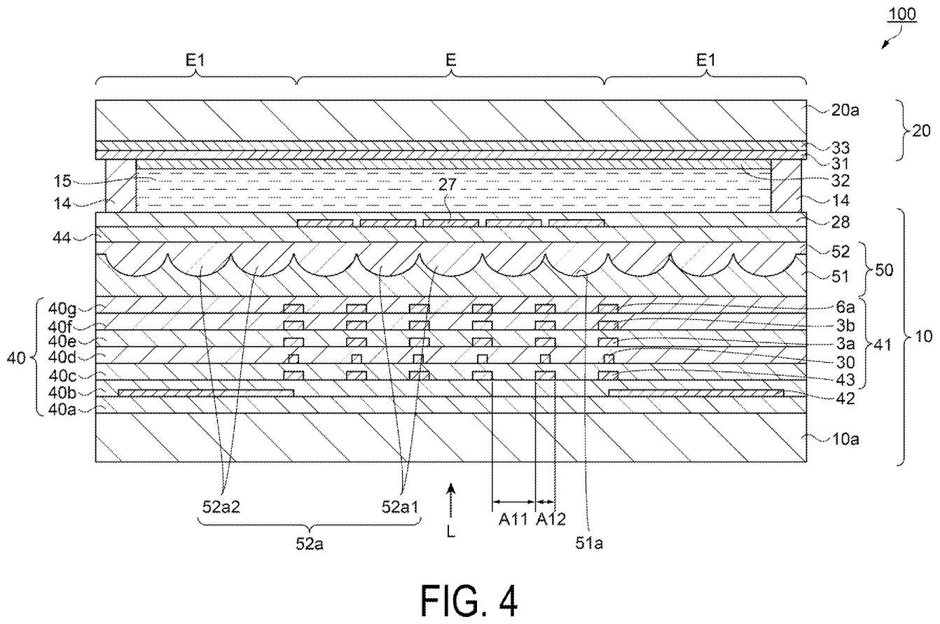

As illustrated in FIG. 4, the liquid crystal apparatus 100 includes the element substrate 10 as an optical substrate and the counter substrate 20 disposed opposite to the element substrate 10. The first substrate 10a constituting the element substrate 10 is, for example, quartz. The element substrate 10 includes an insulating layer 40, a wiring layer 41, a lens body 50 having a plurality of microlenses, pixel electrodes 27, and a first oriented film 28 on the first substrate 10a.

The insulating layer 40 is composed of, for example, silicon oxide, and has a first insulating layer 40a, a second insulating layer 40b, a third insulating layer 40c, a fourth insulating layer 40d, a fifth insulating layer 40e, a sixth insulating layer 40f, and a seventh insulating layer 40g. A light-shielding film 42 formed in a quadrangular frame shape in plan view is disposed between the first insulating layer 40a and the second insulating layer 40b. The wiring layer 41 includes light-shielding films 43, the transistors 30, the scanning lines 3a, the capacitance lines 3b, and the data lines 6a.

The wiring layer 41 described above has light transmission areas A11 through which the light L is transmitted and light-shielding areas A12 in which various wirings are disposed to block the light L. The light transmission areas A11 have substantially quadrangular shapes in plan view, and are disposed in a matrix. The light-shielding areas A12 have a grid pattern in plan view. That is, a light-shielding area A12 is disposed so as to surround a light transmission area A11 in plan view.

The lens body 50 includes a light transmission layer 51 and a lens layer 52. The lens body 50 functions as, for example, a lens that adjusts the spread angle of the light L for each pixel P. The light transmission layer 51 is a transmissive and insulating layer, and is composed of, for example, silicon oxide (SiO₂). Recessed portions 51a are formed in the light transmission layer 51, and the lens layer 52 is disposed covering the recessed portions 51a.

The lens layer 52 is, for example, a material having a refractive index greater than that of the light transmission layer 51, and is composed of, for example, silicon oxynitride (SiON). Lenses 52a of the lens layer 52 are composed of convex lenses that protrude toward the light transmission layer 51. Further, the lenses 52a are formed in hemispherical shapes. The lenses 52a disposed in the display area E are referred to as first lenses 52a1. The lenses 52a disposed in the peripheral area E1 are referred to as second lenses 52a2. The first lens 52a1 are disposed corresponding to each pixel electrode 27 disposed on the lens body 50.

A light transmission layer 44 is disposed on the lens body 50. The light transmission layer 44 adjusts the optical path length of the light L transmitted through the first lenses 52a1. The light transmission layer 44 is composed of, for example, silicon oxide.

The pixel electrodes 27 are disposed on the light transmission layer 44. One pixel electrode 27 and one light transmission area A11 overlap each other in plan view.

The first oriented film 28 formed by oblique vapor deposition of an inorganic material such as silicon oxide is provided on the pixel electrodes 27 and the light transmission layer 44. The liquid crystal layer 15 is disposed on the first oriented film 28. In the liquid crystal layer 15, a liquid crystal, for example, is enclosed in the space surrounded by the seal material 14.

On the other hand, the counter substrate 20 includes the second substrate 20a. The second substrate 20a is, for example, quartz. The counter substrate 20 includes the insulating layer 33, the counter electrode 31, and the second oriented film 32 on the second substrate 20a (on the liquid crystal layer 15 side). The counter electrode 31 includes, for example, a transparent conductive film such as ITO. Similar to the first oriented film 28, the second oriented film 32 is formed by oblique vapor deposition with an inorganic material such as silicon oxide.

The liquid crystal layer 15 takes a predetermined orientation state according to the oriented films 28 and 32 in a state where no electric field is generated between the pixel electrodes 27 and the counter electrode 31. The light L from a projector 1000, which will be described later, is incident from the element substrate 10 side.

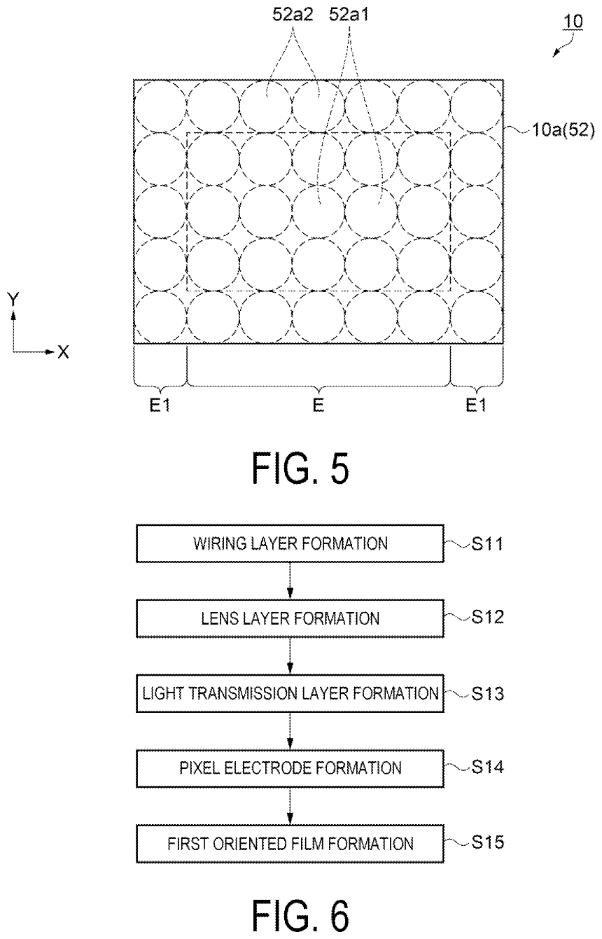

FIG. 5 is a schematic plan view illustrating a structure of the first substrate 10a and the lens layer 52 of the element substrate 10. Further, viewing from the direction illustrated in FIG. 5 is referred to as a plan view.

As illustrated in FIG. 5, the lens layer 52 disposed on the first substrate 10a includes the first lenses 52a1 disposed in the display area E and the second lenses 52a2 disposed in the peripheral area E1 outside the display area E. The first lenses 52a1 are disposed in a matrix in the display area E, for example, in the X direction and the Y direction. Further, the second lenses 52a2 are disposed in a matrix in the peripheral area E1 in the X direction and the Y direction, although the illustration is simplified. That is, the lenses 52a1 and 52a2 are disposed over the entire element substrate 10 in plan view.

In the present embodiment, the shape of the first lens 52a1 and the shape of the second lens 52a2 are the same. Further, the size of the first lens 52a1 and the size of the second lens 52a2 are the same. Further, the density of the first lens 52a1 in the display area E and the density of the second lens 52a2 in the peripheral area E1 are the same. That is, the first lens 52a1 and the second lens 52a2 having the same size and the same shape are disposed over the entire element substrate 10 at uniform intervals.

Next, a method of manufacturing the element substrate 10 will be described with reference to FIGS. 4 and 6. As illustrated in FIG. 6, in step S11, the wiring layer 41 is formed. Specifically, the insulating layer 40 and the wiring layer 41 are formed at the first substrate 10a by using a known film forming method or patterning method. The first substrate 10a is, for example, quartz. The insulating layer 40 is, for example, silicon oxide.

In step S12, the lens layer 52 is formed at the upper layer of the wiring layer 41. Specifically, the lens body 50 including the lens layer 52 is formed at the insulating layer 40. First, the light transmission layer 51 including silicon oxide, for example, is formed at the insulating layer 40 by using a vapor deposition method such as a CVD method.

Next, the light transmission layer 51 is etched to form hemispherical recessed portions 51a. The recessed portions 51a are formed over the display area E and the peripheral area E1 of the light transmission layer 51, that is, the entire surface of the lens layer 52. After that, the lens layer 52 including silicon oxynitride, for example, is formed so as to cover the recessed portions 51a.

Here, when the lens layer 52 is deposited, the element substrate 10 is warped due to the residual stress of the lens layer 52. Since said warpage is an obstacle to the planarization process of the lens layer 52, the warpage of the element substrate 10 needs to be suppressed. Said warpage can be mitigated by annealing, while when the lens layer 52 is provided between the plurality of wiring layers 41 and the pixel electrodes 27, the annealing cannot be performed. This is because when the annealing is performed, there is a risk that the wiring formed of a plurality of aluminum, for example, disposed under the lens layer 52 would be damaged by heat.

Further, as described in JP-A-2019-40153, in the case where the microlens is disposed at a position corresponding to the display area and where the microlens is not disposed at a position corresponding to the peripheral area in the lens layer, when the lens layer is planarized, so-called global steps are formed at the boundary between the portion of the lens layer surface in the display area and the portion of the peripheral area where the microlens is not disposed. Due to the density difference between the display area and the peripheral area, said global steps are generated by the insulating film of the portion of the display area being polished deeper than the insulating film of the portion of the peripheral area. In order to mitigate such global steps, it is conceivable to perform the planarization after removing a part of the portion of the peripheral area by etching with a mask, for example. However, when the warpage of the element substrate 10 is not suppressed, said etching cannot be performed with high accuracy. Therefore, in the case where the warpage of the element substrate is not mitigated, it is difficult to mitigate the global steps.

However, in the present embodiment, since the recessed portions 51a are formed over the entire surface of the light transmission layer 51, the global steps can be mitigated regardless of the influence of said warpage. Therefore, the feature wherein the light transmission layer 51 located on the upper layer of the plurality of transistors 30 have the recessed portions 51a over the entire surface, is more effective than the feature wherein the first substrate 10a located on the lower layer of the plurality of transistors 30 have the recessed portions 51a over the entire surface. This is because the first substrate 10a does not include the wiring layer in the lower layer thereof, so that the anneal be performed to mitigate the warpage.

Next, the upper surface of the lens layer 52 is planarized by using a CMP method, for example. Since the first lenses 52a1 and the second lenses 52a2 are provided from the display area E to the peripheral area E1, for example, the density of irregularities generated on the surface of the lens layer 52 can be made uniform over the entire lens layer 52. This uniformity enables suppressing the occurrence of the global steps between the display area E and the peripheral area E1 on the first substrate 10a. As a result, for example, the cell gap can be made uniform, allowing the display unevenness to be suppressed.

Further, in the process of forming the lens layer 52, since the lenses 52a1 and 52a2 are collectively formed from the display area E to the entire surface of the peripheral area E1, the patterning steps can be reduced to improve the productivity compared with the case where only the second lenses 52a2 of the peripheral area E1 are formed by an additional step.

In step S13, the light transmission layer 44 is formed at the lens layer 52. Specifically, the light transmission layer 44 including silicon oxide, for example, is formed by using a vapor deposition method such as a CVD method, and then the upper surface of the light transmission layer 44 is planarized by a CMP method, for example.

In step S14, the pixel electrodes 27 including ITO, for example, is formed at the light transmission layer 44. Subsequently, in step S15, the first oriented film 28 is formed by, for example, an oblique vapor deposition method. The element substrate 10 is completed by the above.

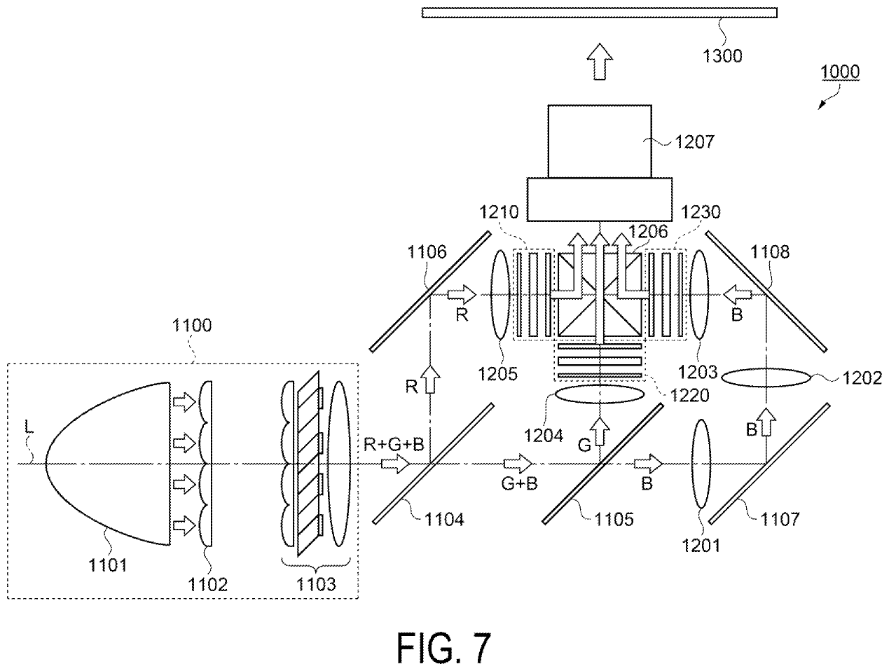

As illustrated in FIG. 7, the projector 1000 of the present embodiment includes a polarizing illumination device 1100 disposed along a system optical axis L, two dichroic mirrors 1104 and 1105 as optical separation elements, three reflection mirrors 1106, 1107, 1108, five relay lenses 1201, 1202, 1203, 1204, 1205, three transmissive liquid crystal light valves 1210, 1220, 1230 as optical modulation means, a cross dichroic prism 1206 as a photosynthetic element, and a projection lens 1207.

The polarized light illumination device 1100 generally includes a lamp unit 1101 being as a light source including a white light source such as an extra-high pressure mercury lamp or a halogen lamp, an integrator lens 1102, and a polarization conversion element 1103.

The dichroic mirror 1104 reflects the red light (R) of a polarized light flux exiting from the polarized light illumination device 1100 and transmits the green light (G) and the blue light (B). The other dichroic mirror 1105 reflects the green light (G) transmitted by the dichroic mirror 1104 and transmits the blue light (B).

The red light (R) reflected by the dichroic mirror 1104 is reflected by the reflection mirror 1106 and is then incident on the liquid crystal light valve 1210 via the relay lens 1205. The green light (G) reflected by the dichroic mirror 1105 is incident on the liquid crystal light valve 1220 via the relay lens 1204. The blue light (B) transmitted by the dichroic mirror 1105 is incident on the liquid crystal light valve 1230 via a light guide system including the three relay lenses 1201, 1202, and 1203 and the two reflection mirrors 1107 and 1108.

The liquid crystal light valves 1210, 1220, and 1230 are each disposed facing an incident surface of each type of color light of the cross dichroic prism 1206. The color light incident on the liquid crystal light valves 1210, 1220, and 1230 is modulated based on video information (video signal) and exits toward the cross dichroic prism 1206.

This prism includes four rectangular prisms bonded together, where on inner surfaces of the prisms, a dielectric multilayer film configured to reflect the red light and a dielectric multilayer film configured to reflect the blue light are formed in a cross shape. The three types of color light are synthesized by these dielectric multilayer films, and light representing a color image is synthesized. The synthesized light is projected onto a screen 1300 by the projection lens 1207 that is a projection optical system, with the image being enlarged and displayed.

The liquid crystal light bulb 1210 is a light bulb to which the above-mentioned liquid crystal apparatus 100 is applied. The liquid crystal apparatus 100 is disposed with a gap between a pair of polarizing elements disposed in a crossed Nicol on the incident side and the emitting side of colored light. The same applies to the other liquid crystal light valves 1220 and 1230.

In addition to the projector 1000, the electronic apparatus on which the liquid crystal apparatus 100 is mounted can be used for various electronic devices such head-up displays (HUD), head-mounted displays (HMD), smartphones, EVFs (Electronic Viewfinder), mobile mini projectors, electronic books, mobile phones, mobile computers, digital cameras, digital video cameras, displays, in-vehicle devices, audio devices, exposure devices and lighting devices.

As described above, the element substrate 10 as the optical substrate of the first embodiment includes the first substrate 10a, the pixel electrodes 27 disposed on the first substrate 10a, the wiring layer 41 including the transistors 30 disposed between the first substrate 10a and the pixels electrodes 27, and the lenses 52a disposed between the pixel electrodes 27 and the wiring layer 41, wherein the lenses 52a has are disposed in the display area E that is an area in which the pixel electrodes 27 are disposed in plan view, and in the peripheral area E1 outside the display area E.

According to this configuration, since the lenses 52a are provided from the display area E to the peripheral area E1, for example, the density of irregularities generated on the surface of the lens layer 52 including the lenses 52a can be made uniform over the entire lens layer 52. This uniformity enables suppressing the occurrence of the global steps between the display area E and the peripheral area E1 on the first substrate 10a. As a result, for example, the cell gap can be made uniform, allowing the display unevenness to be suppressed.

Further, the lenses 52a have the first lenses 52a1 disposed in the display area E and the second lenses 52a2 disposed in the peripheral area E1. The first lens 52a1 and the second lens 52a2 have the same shape.

According to this configuration, since the shapes of the first lens 52a1 and the second lens 52a2 are the same, the concave-convex portion generated in the display area E and the concave-convex portion generated in the peripheral area E1 can be matched. Therefore, it is possible to suppress the occurrence of the global steps between the display area E and the peripheral area E1 on the first substrate 10a.

Further, the liquid crystal apparatus 100 includes the element substrate 10 as the optical substrate described above, the counter substrate 20 disposed opposite to the element substrate 10, and the liquid crystal layer 15 disposed between the element substrate 10 and the counter substrate 20.

According to this configuration, it is possible to provide the liquid crystal apparatus 100 capable of improving the display quality.

Further, since the projector 1000 includes the liquid crystal apparatus 100 described above, it is possible to provide the projector 1000 capable of improving the display quality.

### Second Embodiment

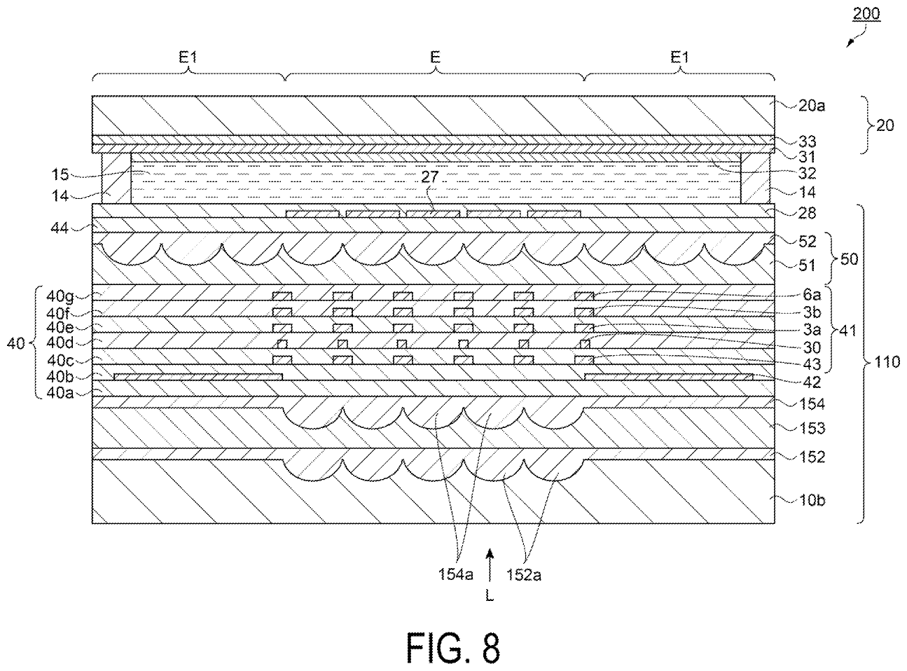

As illustrated in FIG. 8, a liquid crystal apparatus 200 of the second embodiment differs from the liquid crystal apparatus 100 of the first embodiment in that the liquid crystal apparatus 200 includes two lens layers 152, 154 between the first substrate 10a and the wiring layer 41. The other configurations are almost the same. Therefore, in the second embodiment, the parts different from the first embodiment will be described in detail, and the description of other overlapping parts will be omitted as appropriate.

In the liquid crystal apparatus 200 of the second embodiment, a second lens layer 152, a third light transmission layer 153, and a third lens layer 154 are disposed on the first substrate 10b. The structure above the third lens layer 154 (on the liquid crystal layer 15 side) is the same as that of the first embodiment.

Recessed portions are formed in the display area E on the first substrate 10b. The second lens layer 152 is disposed so as to cover the recessed portions. Lenses 152a of the second lens layer 152 function as, for example, lenses that adjust the spread angle of the light L for each pixel P.

The second lens layer 152 is, for example, a material having a refractive index greater than that of the first substrate 10b, and is composed of, for example, silicon oxynitride. The lenses 152a of the second lens layer 152 are composed of convex lenses protruding toward the first substrate 10b. Further, the lenses 152a are formed in hemispherical shapes. Each lens 152a of the second lens layer 152 is disposed so as to correspond to the first lens 52a1 of the lens layer 52.

Recessed portions are formed in the display area E in the third light transmission layer 153. The third lens layer 154 is disposed so as to cover the recessed portions. Lenses 154a of the third lens layer 154 function as, for example, lenses that adjust the spread angle of the light L for each pixel P.

Further, the counter substrate 20 does not have a light-shielding film in the display area E. That is, the counter substrate 20 does not have a black matrix, which is a light-shielding film, at a position corresponding between the pixel electrodes 27 and the pixel electrodes 27 of the element substrate 110 in plan view. Therefore, upon passing through the counter substrate 20, the light L emitted from the counter substrate 20 does not cause a phase difference and does not cause disturbance in the polarization state due to the diffraction by the black matrix. Therefore, the decrease in contrast can be suppressed. In addition, when the counter substrate 20 and the element substrate 110 are combined, the black matrix of the counter substrate 20 and the light-shielding body of the element substrate 110 do not shift in position, namely, no misalignment occurs. Therefore, the aperture ratio of the pixels P is not reduced, which prevents the brightness of the pixels P being reduced.

### Third Embodiment

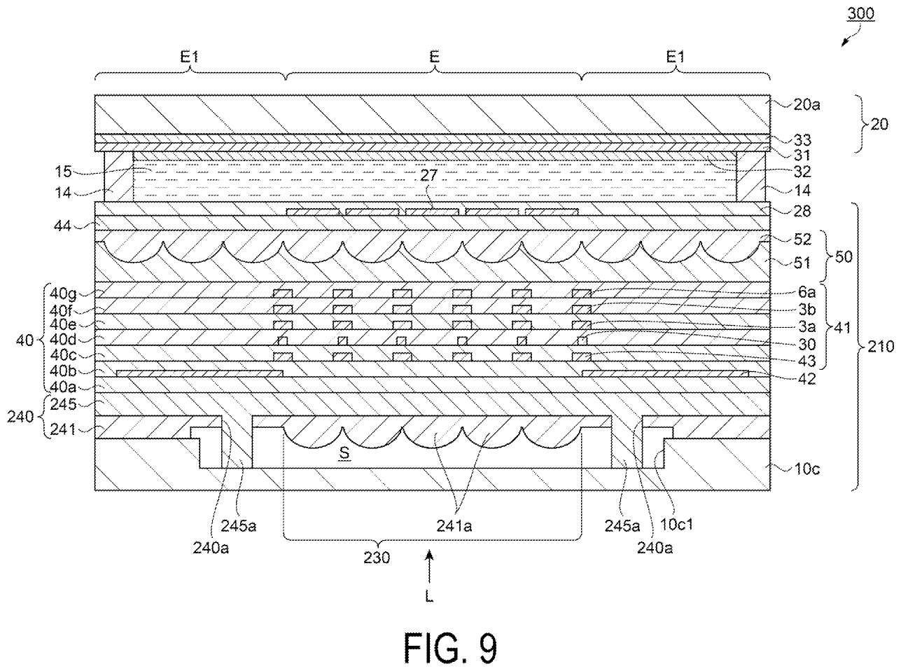

As illustrated in FIG. 9, a liquid crystal apparatus 300 of the third embodiment differs from the liquid crystal apparatus 100 of the first embodiment in that the liquid crystal apparatus 300 includes a lens body 240 having an air layer S between the first substrate 10a and the wiring layer 41. The other configurations are almost the same. Therefore, in the third embodiment, the parts different from the first embodiment will be described in detail, and the description of other overlapping parts will be omitted as appropriate.

In the liquid crystal apparatus 300 of the third embodiment, the lens body 240 is disposed on the first substrate 10c. The insulating layer 40 and the wiring layer 41, the lens body 50, and the pixel electrodes 27 and the first oriented film 28 are formed at the lens body 240 as in the first embodiment.

The first substrate 10c is provided with a recessed portion 10c1 over a part of the display area E and the peripheral area E1. The lens body 240 function as, for example, a lens that adjusts the spread angle of the light L for each pixel P.

The lens body 240 includes the air layer S interposed between the first substrate 10c and the lens body 240, a lens layer 241 including a lens assembly 230 having a plurality of lenses 241a, and a light transmission layer 245. The light transmission layer 245 adjusts the optical path length of the light L transmitted through the lenses 241a. The light transmission layer 245 is composed of, for example, silicon oxide.

The lenses 241a are composed of convex lenses that protrude toward the air layer S and have convex curved surfaces. The lenses 241a have hemispherical shapes. The lenses 241a are composed of, for example, silicon oxide or silicon oxynitride. The refractive index of silicon oxide is, for example, 1.61. The refractive index of silicon oxynitride is, for example, 1.46. The refractive index of the air layer S is, for example, 1.0.

By disposing the air layer S and the lenses 241a from the first substrate 10c side in this manner, the light L incident from the first substrate 10c side is refracted from the air layer S toward the lenses 241a. Therefore, the light L can be efficiently refracted, which allows the light utilization efficiency to be improved.

The lens layer 241 is provided with through holes 240a that communicate with the air layer S. The through holes 240a are closed by a part of the light transmission layer 245 disposed on the lens layer 241.

Specifically, the light transmission layer 245 includes connecting portions 245a coupled to the recessed portion 10c1 of the first substrate 10c through the through holes 240a. By including the connecting portions 245a, the state of the air layer S between the first substrate 10c and the lens layer 241 can be maintained.

The air layer S is composed of a gas such as air. The air layer S may be composed of a vacuum. Further, the air layer S may or may not be an airtight space.

By providing the air layer S between the lens layer 241 and the first substrate 10c, the lens assembly 230 of the lens layer 241 is disposed apart from the bottom surface of the recessed portion 10c1 of the first substrate 10c. The portion of the lens layer 241 outside the lens assembly 230 in plan view is in contact with the first substrate 10c.

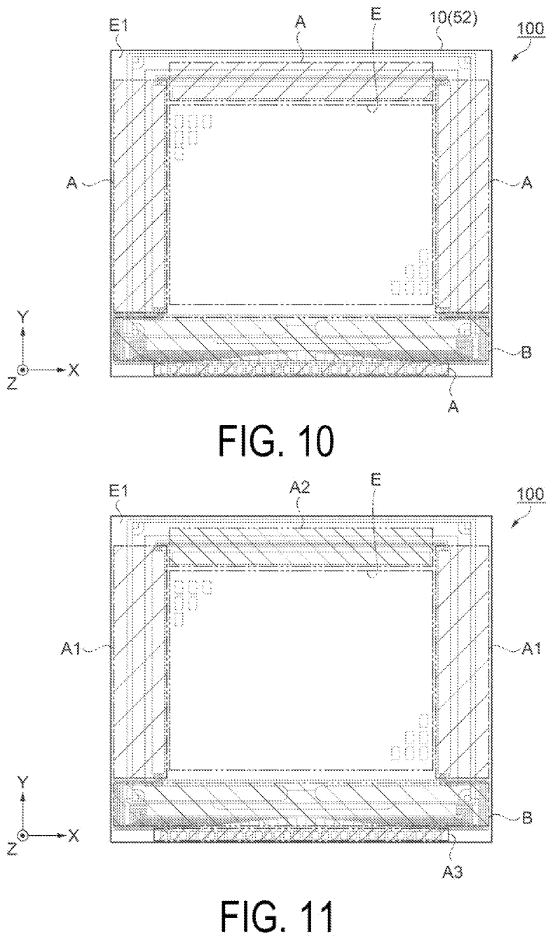

In the first embodiment, the lenses 52a1 and 52a2 having the same shape are disposed at the same density on the entire surface of the lens layer 52 in plan view, in other words, on the entire surface of the element substrate 10. However, without being limited to this, the following may be employed. FIGS. 10 and 11 are plan views of the liquid crystal apparatus 100 viewed in plan view, illustrating the peripheral area E1 divided into several areas. Specifically, the shape and density of the second lens 52a2 in the peripheral area E1 are changed for each area with respect to the first lens 52a1 disposed in the display area E.

In the liquid crystal apparatus 100 illustrated in FIG. 10, for example, whether or not to form the second lenses 52a2 for each area is changed according to the global steps generated by the pattern density of the peripheral wiring including the wiring disposed in the peripheral area E1. The area A is an area forming the second lenses 52a2. The area B is an area that does not form the second lenses 52a2.

In the liquid crystal apparatus 100 illustrated in FIG. 11, for example, the density of the second lens 52a2 is changed for each area according to the global steps generated by the pattern density of the peripheral wiring disposed in the peripheral area E1. The area A1 is, for example, an area where the density of the second lens 52a2 is set to 80%. The area A2 is, for example, an area where the density of the second lens 52a2 is set to 50%. The area A3 is, for example, an area where the density of the second lens 52a2 is set to 70%. The area B is an area that does not form the second lenses 52a2.

According to the above configuration, by not forming the second lenses 52a2 or changing the density of the second lens 52a2 according to the global steps generated in each area, the density of the concave-convex portion on the upper surface of the lens layer 52 can be aligned over the entire surface of the lens layer 52, which enables suppressing the occurrence of the global steps in the lens layer 52.

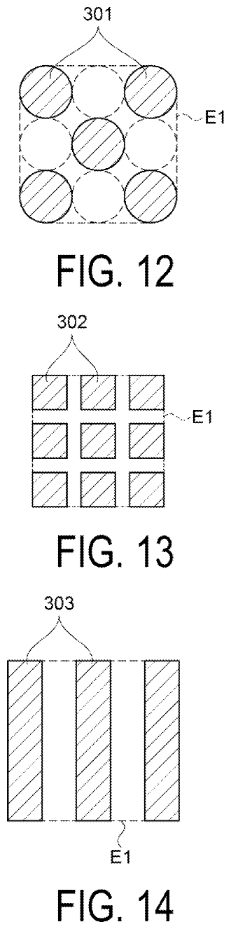

Further, the second lens 52a2 disposed in the peripheral area E1 is not limited to having the same shape and the same size as the first lens 52a1 disposed in the display area E, and may be as follows. FIGS. 12 to 14 are plan views illustrating parts of the recessed portions 301, 302, and 303 as the second lenses disposed in the peripheral area E1. The densities of the recessed portions 301, 302, and 303 in the peripheral area E1 illustrated in FIGS. 12 to 14 are, for example, 50%.

The recessed portions 301 illustrated in FIG. 12 are disposed in a staggered pattern, for example. Further, in the recessed portions 301, without being limited to disposing a recessed portion 301 every other place, the recessed portion 301 may be disposed every third place. Further, the recessed portion 301 is not limited to the same size as the first lens 52a1 disposed in the display area E, and may be smaller or greater than the first lens 52a1.

The recessed portions 302 illustrated in FIG. 13 are disposed in a square shape at regular intervals, for example. In other words, the recessed portions 302 are disposed in dots. The recessed portions 303 illustrated in FIG. 14 are disposed in a striped shape, for example.

As described above, in the recessed portions 301, 302, and 303 as the second lens of the modified example, at least one of the shapes and the densities is different from that of the first lens 52a1 in the display area E, depending on the step between the display area E and the peripheral area E1. According to the above configuration, since the shapes and the densities of the recessed portions 301, 302, and 303 are different according to the step between the display area E and the peripheral area E1, the step generated between the display area E and the peripheral area E1 can be suppressed.

Further, the recessed portions 301, 302, and 303 as the second lens of the modified example at least one of the shapes and the densities is different at the long boundary side (X direction) and the short boundary side (Y direction) of the peripheral area E1. According to the above configuration, since the shapes and densities of the recessed portions 301, 302, and 303 are different at the long boundary side and the short boundary side of the peripheral area E1, it is possible to suppress the step generated in the peripheral area E1.

Further, in the recessed portions 301, 302, and 303 as the second lens of the modified example, at least one of the shapes and the densities varies depending on the density of the peripheral wiring provided in the peripheral area E1. According to the above configuration, since the shapes and densities of the recessed portions 301, 302, and 303 are made different according to the density of the peripheral wiring, it is possible to suppress the step generated in the peripheral area E1.

Further, the lenses 52a1 and 52a2 are not limited to convex lenses having a convex curved surface, and may be concave lenses having a concave curved surface. The concave-convex direction of the second lenses 52a2 in the peripheral area E1 is preferably aligned with the concave-convex direction of the first lenses 52a1 disposed in the display area E from the viewpoint of suppressing the global steps. The same applies to the concave-convex direction of the recessed portions 301 to 303 of the modified examples illustrated in FIGS. 12 to 14.

Further, the lenses 152a, 154a, and 241a described in the second embodiment and the third embodiment are not limited to a convex lens having a convex curved surface, and may be a concave lens having a concave curved surface, or a combination of a convex lens and a concave lens.

The lens body 50 including the light transmission layer 51 and the lens layer 52 described in the above embodiment is not limited to being disposed on the element substrate 10, and may be disposed on the counter substrate 20. Further, the lens body 50 may be disposed on both the element substrate 10 and the counter substrate 20.

Further, without being limited to applying the above-mentioned liquid crystal apparatus 100 to the electro-optical device, the liquid crystal apparatus 100 may be applied to, for example, an organic EL device, a plasma display, an electronic paper (EPD), for example,

What is claimed is:

1. An optical substrate comprising:
a substrate;
a pixel electrode disposed at the substrate;
a wiring layer including a transistor disposed between the substrate and the pixel electrode; and
a lens disposed between the pixel electrode and the wiring layer, wherein
the lens is disposed, in plan view, in a display area that is an area in which the pixel electrode is disposed and in a peripheral area outside the display area.

2. The optical substrate according to claim 1, wherein
the lens includes a first lens disposed in the display area and a second lens disposed in the peripheral area, and
the first lens and the second lens have the same shape.

3. The optical substrate according to claim 2, wherein
the second lens differs from the first lens in at least one of shape and density in accordance with a step between the display area and the peripheral area.

4. The optical substrate according to claim 2, wherein
the second lens on a side of a long side and the second lens on a side of a short side of the peripheral area are different in at least one of shape and density.

5. The optical substrate according to claim 2, wherein
in the peripheral area, peripheral wiring including wiring is provided at the substrate, and
at least one of a shape and a density of the second lens varies depending on a density of the peripheral wiring.

6. An electro-optical device comprising:
the optical substrate according to claim 1;
a counter substrate disposed opposite to the optical substrate; and
an electro-optical layer disposed between the optical substrate and the counter substrate.

7. The electro-optical device according to claim 6, wherein
the counter substrate includes no light-shielding film in a display area.

8. An electronic apparatus comprising the electro-optical device according to claim 6.
